(19) United States
(12) Patent Application Publication
(10) Pub. No.: US 2009/0196049 A1
(43) Pub. Date: Aug. 6, 2009

(54) Lamp, lamp body and method of making lamp

(76) Inventors: Jeffrey P. Buschmann, Lexington, KY (US); James E. Oetken, Winchester, KY (US)

Correspondence Address: OSRAM SYLVANIA INC, 100 ENDICOTT STREET, DANVERS, MA, 01923, US

(21) Appl. No.: 12/012,299

(22) Filed: Feb. 1, 2008

(51) Int. Cl. F21V 7/00

(52) U.S. Cl. 362/310

(57) ABSTRACT

A lamp (10) has a lamp reflector body (12). The lamp reflector body (12) can be formed of a borosilicate glass or a ceramic material; however, the ceramic material is preferred. The lamp body (12) has a forward end wall (16) with an adjacent circular rim (20) that includes one or more recesses (22) formed in an outer surface (23) thereof. A metal ring (26) preferably formed of aluminum, has a radial ledge (28) and a sidewall (30). A lens (24) is positioned on the forward end wall (26) of the lamp body (12) and is held in place by the radial ledge (28). One or more depressions (22a) are formed with the sidewall (30) and into the recesses (22), thereby retaining the lens (24) on the body (12). Preferably, the number of depressions (22a) is equal to the number of recesses (22). A preferred method of creating the depressions is by electro magnetic forming.

### TECHNICAL FIELD

This invention relates to lamps and more particularly to PAR lamps.

### BACKGROUND ART

PAR lamps, in both ceramic and glass versions, provided with a screw base, have been used for many years. The lamps have served both the consumer and industrial markets well. In the glass varieties (usually constructed of a borosilicate glass) stress and thermal expansion have been known to cause glass fractures and failure of the lens adhesive. Ceramic versions have avoided this problem to some degree by employing an aluminum lens retaining ring and a ceramic adhesive; however, this lamp is very sensitive to process changes. The application of the ceramic adhesive is susceptible to curing rate issues, application quantity and oven curing temperatures and times. Even providing the retaining ring with threads failed to solve the problem of retaining the lens, since variations in reflector and lens ring sizes often failed to keep the lens in place. Such failures can cause safety issues because the lamps operate at very high temperatures and, thus, a falling lens (these lamps are often operated in ceiling fixtures) can be extremely hot and create a dangerous situation.

### DISCLOSURE OF INVENTION

It is, therefore, an object of the invention to obviate the disadvantages of the prior art.

It is another object of the invention to enhance reflector lamps.

Yet another object of the invention is the improvement of lensed lamps.

These objects are accomplished, in one aspect of the invention by a lamp comprising a reflector body that has a forward end wall and an adjacent circular rim. One or more recesses are formed in an outer surface of the rim. A circular metal ring has a radial ledge and a sidewall. The ring encloses a lens that is fitted to the forward end wall and encompasses the circular rim. One or more depressions are formed in the metal ring sidewall and extend into the recesses formed in the circular rim, thereby securely holding the lens in place.

In another aspect of the invention a method of making a lamp comprises the steps of first forming a lamp reflector body. The reflector body includes a reflective cavity and has a forward end wall and an adjacent circular rim containing one or more recesses. A circular lens is formed and then a circular metal ring is formed. The ring has a radial ledge and a sidewall. The radial ledge will retain the lens and the sidewall encompasses the circular rim. After positioning the lens and the circular ring to form an assembly, the sidewall of the ring is deformed into the recesses to lock the ring into position on the body.

In a preferred embodiment of the invention the deformation occurs by placing the assembly on the axis of an axial magnetic field generator and inducing the magnetic field generator to radially press portions of the circular metal ring sidewall into the recesses formed on the circular rim of the body.

This operation firmly locks the ring onto the body and thus retains the lens through time and all thermal excursions to which the lamp may be subjected.

The use of a ceramic adhesive is eliminated and there is no need to pre-form threads on the lamp body and the lens retainer.

### BRIEF DESCRIPTION OF THE DRAWINGS

FIG. 1 is an elevation view of a lamp according to an aspect of the invention;

FIG. 2 is a plan view thereof;

FIG. 3 is an elevation view of a lamp body according to an aspect of the invention;

FIG. 4 is a plan view of the lamp body of FIG. 3;

FIG. 5 is a plan view of a metal ring according to an aspect of the invention;

FIG. 6 is a sectional view of the metal ring taken along the ling 6-6 of FIG. 5;

FIG. 7 is an elevation view of the metal ring; and

FIG. 8 is a diagrammatic view of an apparatus employed with an aspect of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

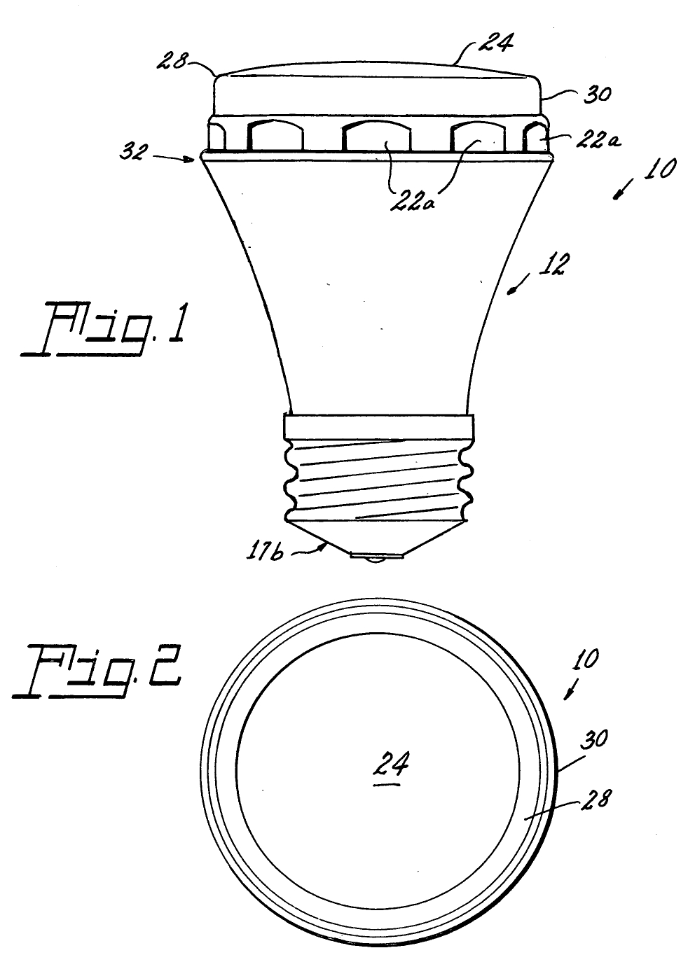

Referring now the drawings with greater particularity, there is shown in FIG. 1 a lamp 10 having a lamp reflector body 12. The lamp reflector body can be formed of a borosilicate glass or a ceramic material; however, the ceramic material is preferred. The lamp body 12 has a forward end wall 16 with an adjacent circular rim 20 that includes one or more recesses 22 formed in an outer surface 23 thereof. The recesses are preferably symmetrically spaced about the rim and, in the case where the lamp is a PAR 16, twelve recesses are the preferred number.

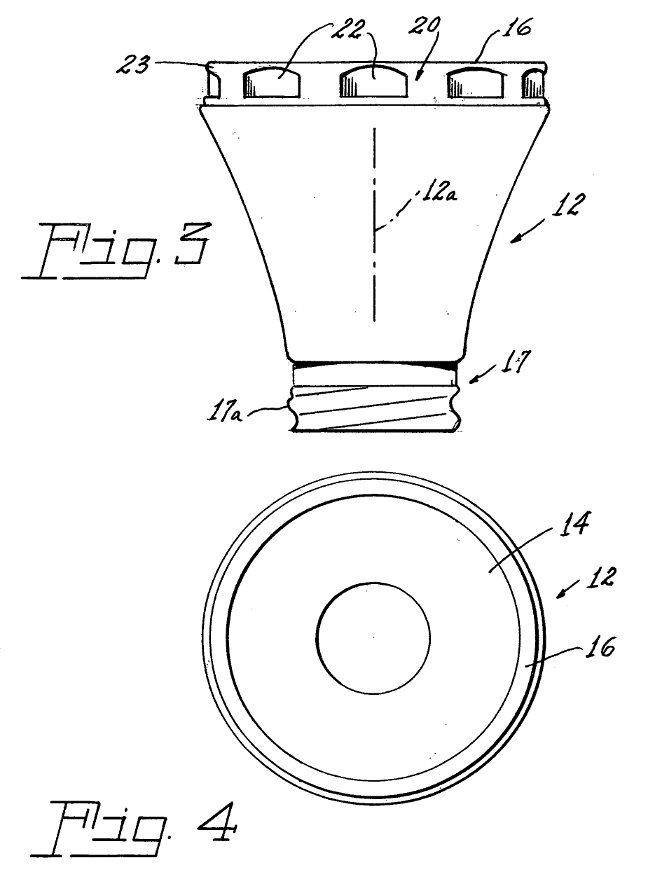

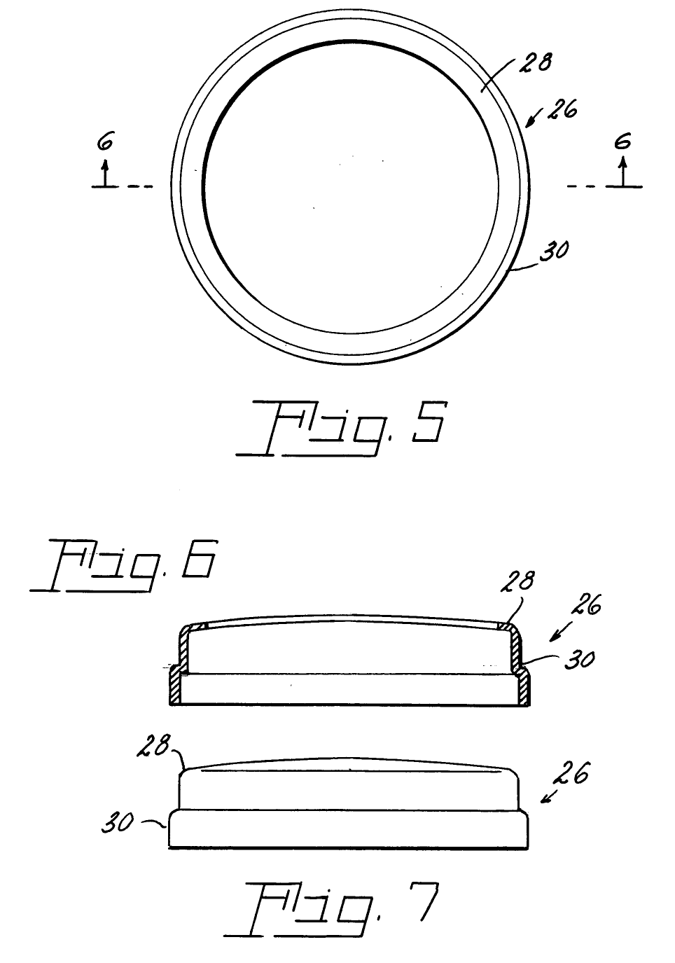

The lamp body 12 is shown more particularly in FIGS. 3 and 4 and is symmetrical about the longitudinal axis 12a. As depicted therein, the rearward end 17 of the lamp can be provided with threads 17a to receive a threaded base 17b, as is known in the art.

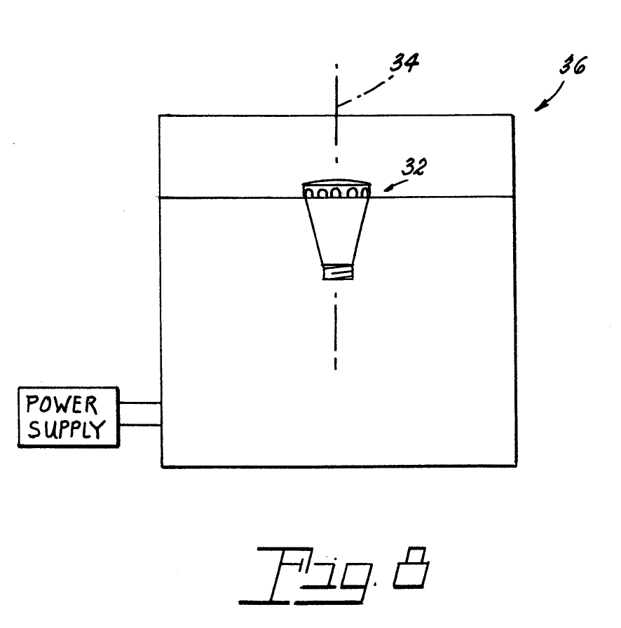

A metal ring 26 (see FIGS. 1 and 5-7) preferably formed of aluminum, has a radial ledge 28 and a sidewall 30. A lens 24 is positioned on the forward end wall 26 of the lamp body 12 and is held in place by the radial ledge 28. One or more depressions 22a are formed with the sidewall 30 and into the recesses 22, thereby retaining the lens 24 on the body 12. Preferably, the number of depressions 22a is equal to the number of recesses 22.

To fabricate the lamp 10, the lens 24 is placed on the forward end wall 16 and the metal ring 26 is placed thereover, the radial ledge 28 retaining the lens, and the sidewall 30 engaging the circular rim 20 and the recesses 22, thus forming an assembly 32. Thereafter, the ring sidewall 30 is deformed to form depressions 22a that extend into the recesses 22, thereby retaining the lens 24 in place. No adhesive is used nor required.

In a preferred embodiment of the invention, the assembly 32 is centered on the axis 34 of an axial magnetic field generator 36, as shown diagrammatically in FIG. 8, and the field generator 36 is induced to provide a magnetic field that presses the sidewall 30 into the recesses 22 to create the depressions 22a. Such a technique is known as electro magnetic forming (EMF). Apparatus for achieving the EMF is available from Pacific Magneform Company, San Diego, Calif. 92111.

Thus there is provided an improved and enhanced lamp that does not have the problems associated with the prior art. The lens is firmly affixed to the lamp body and will not fall off. No adhesive is required to hold the lens in place and assembly operations are easily repeatable and not subject to the variations present in the prior art techniques. Since the technique is performed on the lamp body, it is adaptable to lamps regardless of the light source used within the lamp body, for example, the light source could be a simple incandescent, halogen incandescent, HID or LED.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A method of making a lamp comprising the steps of:
forming a lamp reflector body with a reflective cavity, a forward end wall and an adjacent circular rim, the rim including one or more recesses;
forming a circular lens having a size sufficient to fit adjacent the forward end wall and cover the reflective cavity;
forming a circular metal ring having a radial ledge and a sidewall, the sidewall having a sufficient diameter and sufficient axial extension to enclose the circular lens and the circular rim;
positioning the lens adjacent the forward end wall and positioning the metal ring to cover the lens and circular rim, including the recesses, to form an assembly; and
deforming said metal ring sidewall into the recesses to lock the metal ring in position on the reflector body.

2. The method of claim 1 wherein said deforming step comprises the steps of:
centering said assembly on an axis of an axial magnetic field generator; and
inducing said magnetic field generator to provide a magnetic field sufficient to radially press at least portions of said sidewall into said recesses, thereby locking said circular metal ring in position on said reflector body.

3. The method of claim 1 wherein said reflector body is constructed of ceramic.

4. The method of claim 1 wherein said reflector body is constructed of glass.

5. A lamp reflector body comprising:
a reflective cavity, a forward end wall and an adjacent circular rim, said rim including one or more recesses formed in an outer surface thereof.

6. A lamp comprising:
a lamp reflector body having a forward end wall and an adjacent circular rim including one or more recesses formed in an outer surface thereof:
a circular metal ring having a radial ledge and a sidewall, said sidewall enclosing a circular lens positioned on said forward end wall and said circular rim; and
one or more depressions formed in said sidewall and extending into said recesses, whereby said circular metal ring retains said lens on said reflector body.
